(19) United States
(12) Patent Application Publication
(10) Pub. No.: US 2007/0112462 A1
(43) Pub. Date: May 17, 2007

(54) Method for detecting if command implementation was completed on robot common framework, method for transmitting and receiving signals and device thereof

(76) Inventors: Jong-Myeong Kim, Seoul (KR); Dong-Hyun Yoo, Seongnam-si (KR); Jae-Yeol Kim, Gunpo-si (KR)

Correspondence Address: HARNESS, DICKEY & PIERCE, P.L.C., P.O. BOX 8910, RESTON, VA, 20195, US

(21) Appl. No.: 11/594,929

(22) Filed: Nov. 9, 2006

(30) Foreign Application Priority Data
Nov. 10, 2005 (KR) 10-2005-0107669
Nov. 10, 2005 (KR) 10-2005-0107667
Nov. 10, 2005 (KR) 10-2005-0107671
Nov. 10, 2005 (KR) 10-2005-0107672
Nov. 10, 2005 (KR) 10-2005-0107673

(51) Int. Cl. G06F 19/00

(52) U.S. Cl. 700/245

(57) ABSTRACT

In the present invention, a common robot interface framework (CRIF) is defined. CRIF is a standard of a common interface using a kind of imaginary robot for the purpose of the abstraction of hardwares in order to decrease the dependency of an application on hardware platforms and to increase a transplantation and a CRIF-framework for supporting the interface in a client-server environment.

This application claims the benefit of Korean Patent Application No. 10-2005-0107669, filed on Nov. 10, 2005; Korean Patent Application No. 10-2005-0107667, filed on Nov. 10, 2005; Korean Patent Application No. 10-2005-0107671, filed on Nov. 10, 2005; Korean Patent Application No. 10-2005-0107672, filed on Nov. 10, 2005; and Korean Patent Application No. 10-2005-0107673, filed on Nov. 10, 2005, which are hereby incorporated by reference as if fully set forth herein.

### BACKGROUND OF THE INVENTION

1. Field of the Invention

The present invention relates to a method for detecting if a command implementation is completed on a robot common framework, a method for transmitting and receiving signals and a device using these methods.

2. Description of the Related Art

An industrial robot market started to grow from 1980s at a high speed in the background of development of labor-integrated industries such as an automobile and an electronic industry and was extended in earnest as a robot entered into a production line. However, as the industrial robot market enters an age of maturity in 1990s, the stagnation of the market becomes a chance to seek for an industry in a new field and a development of a new technology. The robot in the new field avoiding an industrial robot which mainly repeats simple operations in the existing fixed environment has been developed into a kind of a service robot providing with a service close to human beings' and positively coping with the changing society, as recently a social request for household affairs and other living supports is extended and an aging society is settled. Especially, a robot field is forming a new robot market called an intelligence communication technology based intelligence service robot together with a remarkable development of a semiconductor, a computer and a telecommunication technology. For example, the commercialization of an intelligence service robot derived from a pet robot A made by S Inc. avoids a conception that a robot is used only in the field for replacing a human labor and becomes a chance to extend an entertainment and a recognition of roles as people's partner.

The domestic intelligence service robot industry presents elementary intelligence robot products like an entertainment robot and a home robot by about 20 major venture firms and big companies try to develop independent intelligence robots together with the development of intelligence household appliances. S Inc. developed a toy robot ANTOR, a household robot iComar(™) and the succeeding model iMaro(™) and is planning to sell them within one or two years, and L Inc. presented a cleaning robot RobotKing.

Especially, as big companies have technologies in relatively various business fields, an affluent research labors and a capital, they are expected to shortly overcome the inferiority of technologies in comparison with the existing small-sized leading companies and lead this field soon.

The domestic industry robot ranks the 4^{th} in the world in view of a production scale to be helpful in strengthening a competition of manufacturing industry like semiconductor and automobile but is highly dependent on overseas technology and robot core parts. Therefore, the domestic industry robot has a low competitiveness compared to advanced countries and the existing industry loses vitality due to the recent stagnation of industries. In an international tendency of a development of robot industry, a lot of small & medium sized venture firms have developed robots for the purposes of household, entertainment and education since 2000 to commercialize. An international robot soccer competition and an international intelligence robot exhibition were hold in Korea to increase the possibility of industrializing a domestic intelligence robot gradually. D Inc. presented a human robot Lucy with 16 joints using a cheap RC servo motor and a plurality of education and research robots and R Inc. has presented growth type toy robot DiDi and TiTi with the shape of a rat and a gladiator robot for fighting. Microrobot Co., Ltd. is commercializing an educational robot Kit and a contest robot and is now developing a module robot as a task for developing the next generation robot. Our technology in cooperation with KIST developed and exhibited a household guidance and cleaning robot Issac and presented a cleaning robot and is now developing a public exhibition robot as the next generation task. Y Inc. commercialized a soccer robot Victo and developed household educational robots Pagasus and Irobi and is preparing for commercialize them. H Inc. commercialized a research robot and a soccer robot and developed a defense robot and a cleaning robot Ottoro. A plurality of companies contribute to the industrialization focusing on educational and pet robots.

According to a report regarding IT new growing power, an intelligence service robot is named as a ubiquitous robotic companion (hereinafter, “URC”) to promote the revitalization of industry based on a business model and the development of technology. Here, URC is defined as “a robot standing by me anytime and anyplace to provide me with necessary service” and a network added URC conception is introduced to the existing robot conception to provide various state of-the-art functions and services and to remarkably improve a mobility and a human interface. Therefore, it is expected to extend the possibilities to provide various services and entertainments with a cheaper price in view of users. The URC is considered to connect to a network infra and have an intelligence and further includes a hardware mobility and software mobility in view of mobility.

The URC coupling a robot with a network has overcome their limitations and presents a new possibility to plan the growth of a robot industry. The existing robot had to include all necessary functions and technical burdens in itself and thus it has technical limitations and cost-related problems. However, the functions are shared by the outside through a network and it is possible to reduce costs and increase usefulness. In other words, functional possibilities brought by the development of an IT technology are joined with a robot to secure a human-friendly human interface with the more free shape and a larger ranged mobility and develop a robot industry based on a human emphasized technology.

Under the current circumstance without the standardized robot, the functions of a robot and almost all aspects with respect to the realization of a robot including the structure or a method for controlling of a robot and a protocol for controlling the robot cannot help being diversified in accordance with the intent of a manufacturer and a designer. Applications developed with an objective of a specific robot platform have a possibility not to be operated in other platforms. Moreover, as hardware-dependent portions are scattered in the programs, the task of transplantation is also difficult, causing the double development of robot functions and applications, which is considered to be an important element disturbing the development of a robot technology.

The most representative method to solve the above problems is to abstract the hardware-dependent portions which are changed in accordance with a robot platform. In other words, as shown in FIG. 1, an application uses only hardware functions and services of a robot provided by the abstracted hardware class to decrease the dependence of the hardware on a specific robot.

In the meantime, as various sensors, actuators and control boards constituting a robot device have improved capabilities and have been modulized, the recent robots are mounted with a plurality of control boards. In a recent tendency, a platform capable of generally controlling the shape of a robot through a communication between these boards is being extended. A robot is controlled from a remote place through a network together with the tendency of modulization and dispersion of the inside of a robot and a dispersion in the type of providing a service is also improved.

### SUMMARY OF THE INVENTION

Accordingly, the present invention has been made keeping in mind the above problems occurring in the related art, and the first object of the present invention relates to a method for confirming whether a command implementation of a robot abstraction class is completed on a framework which make it possible to use a common interface with respect to a URC robot device and an interface on a client-server structure.

The second object of the present invention relates to a method for transferring a camera image obtained in a robot abstraction class by the control of a robot application to a robot application on a robot common framework.

The third object of the present invention relates to a method for managing a sound signal of the robot application and the robot abstraction class on a robot common framework.

The fourth object of the present invention relates to an intelligence service robot transferring one of signals output to indicate directions of a sound source and a sound signal without transferring all the sound signals recognized in a plurality of sound recognizable mikes in view of transferring a sound signal in an intelligence service robot to a server and a method for transferring a sound signal of an intelligence service robot.

### BRIEF DESCRIPTION OF THE DRAWINGS

The above and other objects, features and advantages of the present invention will be more clearly understood from the following detailed description taken in conjunction with the accompanying drawings, in which:

FIG. 1 shows a method of abstracting a robot hardware;

FIG. 2 is a view showing a robot imaginary model and a method for approaching an imaginary model in a client-server environment;

FIG. 3A is a view showing all regions and a local coordinate system;

FIG. 3B shows a local coordinate system for sensor locations;

FIG. 4A shows the structure of a CRIF-Framework;

FIG. 4B shows a flow of managing the CRIF-Framework;

FIG. 5 is a block diagram showing a process for checking if a command implementation is completed;

FIG. 6 is a block diagram showing a process for checking if a command implementation is completed in accordance with another embodiment of the present invention;

FIG. 7 shows the structure of a packet whether a command implementation is completed in accordance with an embodiment of the present invention;

FIG. 8 is a schematic view showing a process for transmitting and receiving an image in accordance with an embodiment of the present invention;

FIG. 9 is a flow chart showing a process for transmitting and receiving an image in accordance with an embodiment of the present invention;

FIG. 10 shows the data structure of an image in accordance with an embodiment of the present invention;

FIG. 11 is a conceptual view of a process for transmitting and receiving a continual image in accordance with an embodiment of the present invention;

FIG. 12 shows the data structure of a request command to transfer an image in accordance with an embodiment of the present invention;

FIG. 13 shows the data structure of a command to stop transferring an image in accordance with an embodiment of the present invention;

FIG. 14 is a block diagram showing a process for transmitting and receiving a continual image in accordance with an embodiment of the present invention;

FIG. 15 is a block diagram showing a transfer of waves and a flow of reproduction commands in accordance with an embodiment of the present invention;

FIG. 16 is a structural view showing a transfer of waves and a reproduction command packet;

FIG. 17 is a block diagram showing the storing waves and a flow of reproduction commands in accordance with an embodiment of the present invention;

FIG. 18 is a structural view showing a transfer of waves and a reproduction command packet;

FIG. 19 is a block diagram showing a flow of commands for reproducing a wave in accordance with an embodiment of the present invention;

FIG. 20 is a structural view showing a wave reproduction command packet;

FIG. 21 is a flow chart showing storing waves and a flow of reproduction commands in accordance with an embodiment of the present invention shown in FIG. 7;

FIG. 22 is a flow chart showing a flow of a wave reproduction command in accordance with an embodiment of the present invention;

FIG. 23 is a flow chart showing a process for performing an embodiment of a method for transferring a sound data of an intelligence service robot in accordance with the present invention;

FIG. 24 shows a part of an embodiment of an intelligence service robot in accordance with the present invention; and

FIG. 25 shows an example of a sound signal recognized by a sound recognizing mike using waveforms.

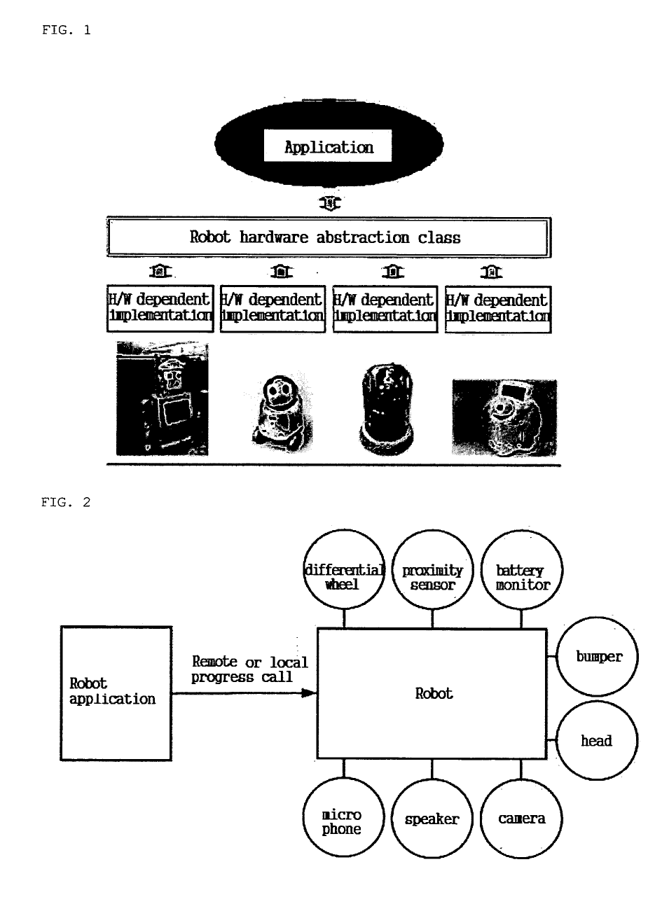

### DETAILED DESCRIPTION OF THE PREFERRED EMBODIMENTS

In the present invention, a common robot interface framework (CRIF) is defined. CRIF is a standard of a common interface using a kind of imaginary robot for the purpose of the abstraction of hardwares in order to decrease the dependency of an application on hardware platforms and to increase a transplantation and a CRIF-framework for supporting the interface in a client-server environment.

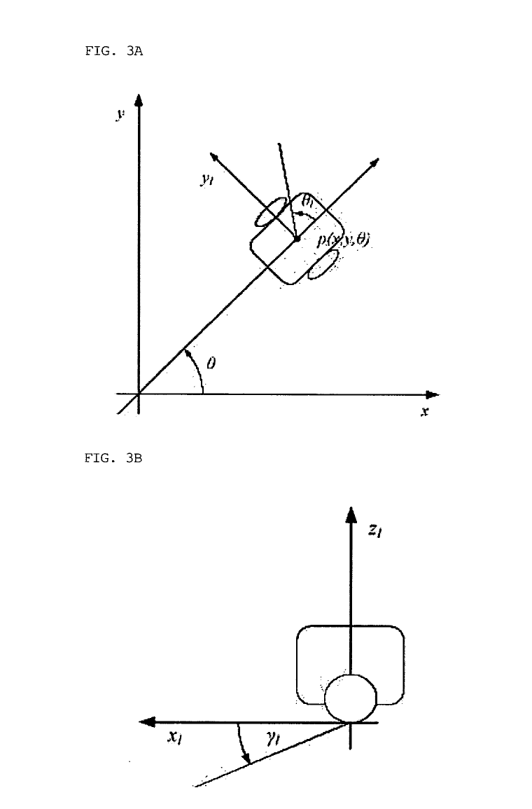

FIG. 2 shows a robot imaginary model and a method for approaching an imaginary model in a client-server environment. The robot application approaches hardware sources of a robot using a common interface in accordance with the standard defined in the present invention or controls a robot.

In the present invention, as shown in FIG. 2, a model for a kind of imaginary robot is set up and a common interface thereof is provided. It is preferable that the imaginary robot be defined as a robot having a differential type wheel driving device, a pan-tilt head with a camera, a distance sensing device capable of measuring the distance from the object outside the robot, a collision detecting bumper sensor, sound receiving mikes, sound outputting speaker device, an image device for obtaining an image outside the robot and a battery voltage detecting device.

As shown in FIG. 2, the common interface defined in the present invention provides an interface for approaching attachments of a robot but does not define an interface for approaching the other devices. The interface framework defined in the present invention has an extended structure where the common interface defined in the present standard can be used in the client-server environment. At this time, the thing that the robot application and the robot device constitutes a client-server structure refers to the environment that the robot application mainly exists inside the robot but is operated in a computing node different from the robot attachments. However, the robot application can be adjusted in a remote environment operated in the external processor of a robot device.

The common interface defined in the present invention can be applied to a robot having one or more devices of robot attachments. In addition, the common interface framework defined in the present standard can be applied to a case for supporting a method for calling a remote function when a robot is communicated with a robot device.

The objects who are directly affected by the common interface standard of the present invention are a robot application developer and a robot developer. The robot application developer develops a robot application in accordance with the common interface standards prescribed in the present standard and the robot developer assumes a robot hardware dependent embodiment in order to support the common interface standards prescribed in the present standard.

The object who is directly affected by the interface framework standard of the present invention is a framework developer. The framework developer must develop a framework in accordance with the standard defined in the present invention. A robot application developer or a robot developer is not affected by a framework of the present standard.

As a framework is in charge of a client-server communication between a robot application and a robot, a robot application developer or a robot developer must comply with the common interface.

It is preferable that a kind of models for a robot platform be set up and a common interface be defined based on the model in order to obtain a standard of an interface approaching a robot device, because the device hardwares constituting a robot have various characteristics and kinds by platforms or devices. In the present invention, an abstraction robot model is presented and a standardized interfaced API for approaching the functions and the services of a robot is defined in order to decrease the dependence on a specific robot device.

A robot is an individual supporting a common interface standard defined in the present invention and an embodiment of a common interface realizes a common interface standard to be suitable for the device characteristics of a robot. In the present invention, models of a kind of imaginary robot is set up and a common interface thereof is provided in order to provide a robot application with a common interface.

All the applications in the CRIF-Interface order a kind of imaginary robot to operate. In case that a specific robot is controlled through such imaginary robot model, an application is advantageous in that the dependence of a specific robot on hardwares can be dismissed.

However, if a specific robot platform has specific functions or tools which are not defined in the imaginary robot model, the specific functions or tools are not allowed to use by the CRIF-Interface. Thus, it is necessary to define flexible interface sets including as much functions as various robots have.

However, in case that the functions which are not substantially used are included, the CRIF-Interface gets complicated unnecessarily and other embodiments get complicated in accordance with specifications of a hardware, also.

Accordingly, as described above, an imaginary robot model defined in the present invention consists of a differential typed wheel driving device, a pan-tilt head with a camera, a distance sensing device capable of measuring the distance from the object outside the robot, a collision detecting bumper sensor, sound receiving mikes, a sound outputting speaker device, an image device for obtaining an image outside the robot and a battery voltage detecting device.

Table 1 shows devices provided in the robot defined in the present invention.

TABLE 1

| Classification | Standards |
|---|---|
| Moving device | Differential drive type wheel having two main |
| | drive motors |
| Head unit | One pan-tilt head controller |
| Distance sensor device | Arrange N sonar or infrared ray distance sensors |
| Bumper sensor | Arrange N bumper sensors |
| Sound input device | N mikes |
| Sound output device | N speakers |
| Image input device | N cameras |
| Battery monitor | One battery voltage sensing device |

The units by parameters for interface for moving a robot is shown in table 2.

TABLE 2

| Parameter | Unit |
|---|---|
| Distance | M |
| Time | second |
| Angle | Radian |
| Linear velocity | m/s |
| Angular velocity | Rad/s |
| Linear acceleration | m/s² |
| Angular acceleration | Rad/s² |

As shown in FIG. 3A, a coordinate system uses a three-dimensional angular coordinate system consisting of x, y and z. In a local coordinate system, a front direction of a robot is an x-axis, a left side is a y-axis and a vertical direction is z-axis. θ is an angle made by x-axis and y-axis and the front direction of a robot is 0° and the left side of the robot is 90°. γ is an angle made by xy-plane and z-axis. (refer to FIG. 3b)

Hereinafter, an interface for driving a robot is defined as follows.

A robot manager provides with information of initialization and finishing of the entire robot and a device of a robot platform.

A movable interface performs commands of driving and stopping a wheel provided with a robot and establishes the maximum velocity and an acceleration of a robot and can know the current velocity and position. It performs controlling a velocity and a position using an encoder information, internally.

The commands of controlling a velocity include SetWheelVel()function controlling directly the velocity of both wheels and SetVel()function setting a linear velocity and an angular velocity of a robot and the commands of controlling positions include a Move()function moving in a forward or a backward direction, a Turn()function rotating by the determined relative angle and a Rotate()function rotating the given relative angle and a rotational radius.

Besides, there are a function capable of obtaining the current velocity and the position and functions capable of setting up a linear acceleration, an angular acceleration, the maximum linear velocity and the maximum angular velocity and Stop() for stopping a robot and an EmergencyStop() for stopping fast in an emergency.

The control for positions in a wheel implementation uses a local robot coordinate system based on the current position of a robot. In other words, if Move() or Turn() function is called, a regular distance is moved or a regular angle is rotated based on the positions of a robot at the point.

The control of a head unit includes an information of a robot head unit, the current angle of the head unit, and information of commands to set up a saturated velocity of robot head pan and tilt and rotate the head by a predetermined angle at a designated rotation velocity.

The control of a camera includes an information of a camera resolution, an information of a zoom driver provided in the camera, a list of supportable resolutions by the designated camera, a camera ID, the current resolution of the designated camera, setting up a resolution of the designated camera, the current frame rate of the designated camera, setting up frame rates of the designated camera, obtaining and stopping the designated image information, storing and returning the obtained to a buffer, information of a zoom of the designated camera, a zoom factor and an information of performing zoom operations.

A proximity sensor interface is an interface of a sensor array, from which the distance with an obstacle like a sonar sensor or an infrared ray sensor provided in a robot can be found out. Sets of sensors with the same characteristics are called a sensor array. If several sonar sensors with the same characteristics are arranged, they constitute one sensor array. Several sensor arrays may exist and are classified by I.D.

If a robot collides with an external obstacle, a bumper sensor interface is an interface of the bumper sensors which may inform of the collision, the bumper sensor interface corresponding to a bumper provided in a robot and an array of infrared ray sensors recognizing a very short distance. The bumper informs of collisions with an obstacle, if any. Sets of sensors with the same characteristics are called a sensor array. If several sonar sensors with the same characteristics are arranged, they constitute one sensor array. Some sensor arrays like the above can exist and is classified by I.D.

A battery monitor checks out a battery voltage with respect to a main power.

A speaker outputs a sound data through a speaker and a mike control obtains a sound data from the open mike channel.

The CRIF-framework for communication via the above interface is defined as below.

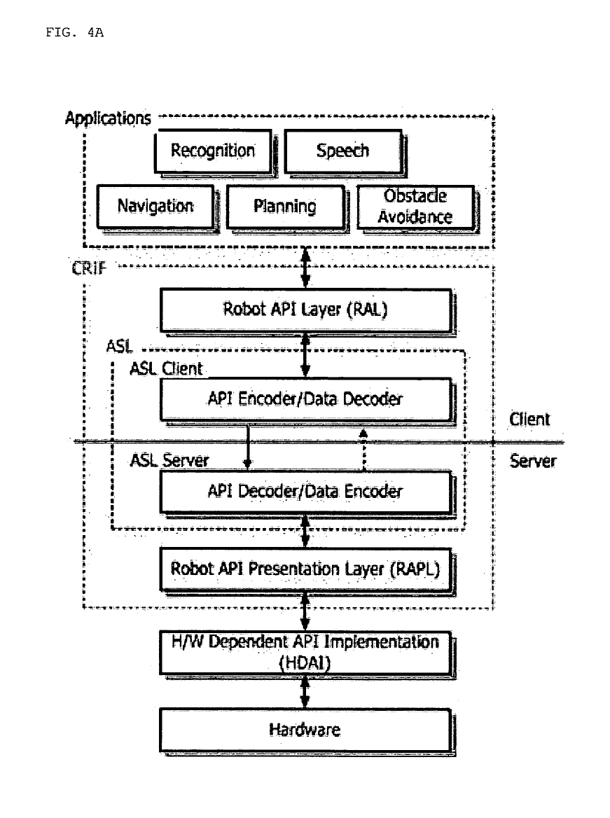

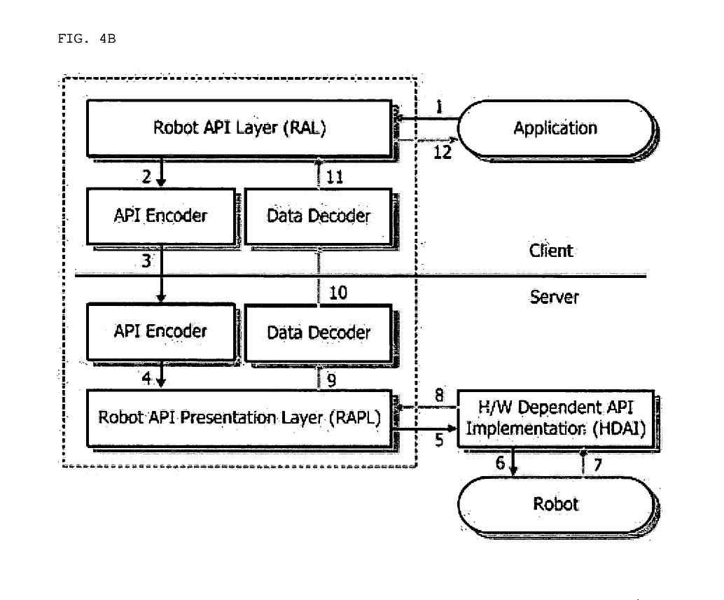

FIG. 4 shows the structure of a CRIF-Framework defined in the present invention.

The CRIF-Framework prescribes a framework for extending a CRIF-Framework into a client-sever environment. The components constituting the CRIF-Framework includes a class with a CRIF-interface used by an application developers for driving a robot, a class for embodying an API defined in the CRIF-Interface by robot platform developers of a robot in the server side for really driving a robot and a class in charge of communicating two classes.

As mentioned above, the CRIF-Framework provides with a common framework used for developing each system by an application developer or a robot hardware developers. The application developer in the client side can control and approach a robot hardware using an interface provided by the CRIF-Framework and the robot hardware platform developer in the server side realizes the contents of API to comply with each platform so that a robot is driven to be appropriate to the definitions of API defined in the CRIF-Framework, leading to controlling and approaching the real hardware required by the client side.

As shown in FIG. 4, the CRIF-Framework is placed at the client side and the server side at the same time and consists of Robot API Layer(RAL), API Sync Layer(ASL) and Robot API Presentation Layer(RAPL). In addition, some of RAL and ASL are positioned in the client side and some of ASL and RAPL are positioned in the server side. In other words, a developer in the client side approaches RAL to use an interface supported by the CRIF-Framework and approaches RAPL to use RAPL to use an interface supported by the CRIF-Framework.

The Robot API Layer(RAL) provides with interfaces used by application developers. It is possible to approach each device of a robot by using only the interface provided by RAL and it is not possible to approach it by the other methods. In other words, RAL provides with approaches to the abstracted robot models and contact points for operations but the API defined in the CRIF-Interface is not realized in RAL. RAL just plays a role in transmitting the CRIF-Interface function called in the application to ASL and CRIF-Interface is realized in H/W Dependent API Implementation (HDAI) in server side.

The interface provided by API Sync Layer (ASL) is transmitted to Robot API Presentation Layer prepared for realizing functions in the server side through ASL. In other words, ASL plays a role in connecting RAL and RAPL. ASL consists of two sub-classes in other words, a class connected to RAL in the client side and a class connected to RASL in the server side. Each sub-class has the same roles but different detailed functions.

The API function called in RAL in the client side is transmitted to API Decoder in the server side through API Encoder and a return value after a hardware is operated by the transmitted API function or a data value representing the state of a robot hardware is transmitted to Data Decoder in the client side by Data Encoder in the server side. Finally, the functions of ASL perform Encode/Decode functions of API function called in the application and Encode/Decode functions of data transmitted from the robot hardware.

Robot API Presentation Layer (RAPL) plays a role in connecting to Dependent API Implementation (HDAI) of a hardware to be prepared by hardware developers in the server side in order to realize API defined in RAL. It really plays a role as a counterpart of RAL and its constitution is the same as RAL. Their differences are in that API of RAL is called in the application in case of RAL, but RAPL plays a role as a reference point to designate API which is realized in HDAI, therefore a coding task for operating API is performed in HDAI. In other words, RAPL plays a role as an access point in HDAI. Finally, it is possible to approach CRIF-Interface through RAL in view of developing applications and to approach CRIF-Interface through RAPL in view of developing hardwares. ASL plays a role in connecting RAL to RAPL and it is impossible to directly approach ASL in view of developing applications/Hardwares.

A client is connected to a server through ASL in CRIF-Framework. ASL consists of two sub-classes of ASL client having API Encoder/Data Decoder and ASL Server having API Decoder/Encoder. The connection between a client and a server is performed by corresponding elements like API⇄API Decoder and Data Encoder⇄Data Decoder, which are elements correspond to each other. If a specific API is called in the client, this is transmitted to API Decoder in the server side through API Encoder and a return value according to the operation results of API is transmitted to the Data Decoder in the client side through Data Encoder and transmitted to the application.

When realizing it, two sub-classes can be connected with various methods. The connection of each Encoder/Decoder is performed by the methods of Socket, COM and CORBA, and the connection methods are selected like the example of table 3 in accordance with an operation system of a client or a server side. As known from the example of Table 3, a connection method is determined in accordance with the operating system of a client or a server side and possible connection methods dependent on an operating system should be supported.

TABLE 3

| Operating System | | Connection Method | | |
|---|---|---|---|---|
| Client | Server | Socket | COM | COBRA |
| MS Windows | MS Windows | ◯ | ◯ | ◯ |
| MS Windows | Linux | ◯ | X | ◯ |
| Linux | MS Windows | ◯ | X | ◯ |
| Linux | Linux | ◯ | X | ◯ |

With reference to FIG. 4B, a processing order between applications and a robot on a client/server structure using CRIF is as follows.

First, API defined in RAL is called in order to operate a robot in an application (1). Information of the called API (function name or parameter, etc.) is transmitted to API Encoder (2). Information of the transmitted API is transmitted to API Decoder in accordance with a protocol according to the connection state of ASL. If ASL is connected by TCP/IP, it is transmitted in the shape of a predetermined packet, and if ASL is connected by DCOM or COBRA, it is performed in accordance with an approach of an interface (3). API which is the same as the API called in (1) in accordance with API transmitted to Decoder is called on RAPL (4). API on RAPL calls API of HDAI which is realized (5). The API of the called HDAI is transformed into a command which can be internally understood by a robot device and is transmitted to the robot device (6). The performed results are continuously transmitted into a return value of the called API. This is just a process to transmit the result value after the API called in (1) really operates a hardware. For example, after API reading in a value of a supersonic sensor is called and really operated, the distance value obtained from each sensor is transmitted to an application by the process.

As described above, CRIF-Interface and CRIF-Framework of the present invention defined as above control a camera to obtain images. The data structure or commands for controlling the above images are defined concretely as follows,

Data structure

struct CameraResolution {
int Hor; represents a horizontal resolution
int Ver; represents a vertical resolution
} Information of camera resolution
struct CameraResolutionArray{
int NumberOfMembers; represents number of supportable

resolution

CameraResolution *Members; represents each resolution
} array list of camera resolutions
struct ZOOM_INFO {
bool is_zoom;
int minZoom;
int maxZoom;
} Information of zoom driver provided in a camera

CameraResolutionArray* GetSupprotedResolutions(int nID)

(1) parameter
[in] nID designates a camera ID

(2) return value

Returns a list of supportable resolutions of the designated camera. If operations of a function fails, returns null.

int GetMaxFrameRate(int nID)

(1) parameter
[in] nID designates a camera ID.

(2) return value

Returns the maximum frame rate of a designated camera (frame/sec).

CameraResolution* GetResolution(int nID)

(1) parameter
[in] nID designates a camera ID.

(2) return value

Returns a list of supportable resolutions of the designated camera. If operations of a function fail, returns null.

bool SetResolution(int nID, CameraResolution Resolution)

Establishes a resolution of a designated camera.

(1) parameter
[in] nID camera ID
[in] Resolution camera resolution

(2) return value

If a function is operated successfully, returns true but if fails, returns false.

int GetFrameRate(int nID)

Returns the current frame rate of a designated camera (frame/sec).

(1) parameter
[in] nID camera I.D.

(2) return value

The current frame rate of designated camera(frame/sec).

bool SetFrameRate(int nID, int nRate)

Establishes a frame rate of a designated camera(frame/sec).

(1) parameter
[in] nID camera I.D.
[in] nRate frame rate

(2) return value

If a function is operated successfully, returns true but if fails, returns false.

Bool StartCapture(int nID)

Starts to obtain information of designated image.

(1) parameter: None

(2) return value

If a function is operated successfully, returns true but if fails, returns false.

Bool StopCapture(int nID)

Stops obtaining an information of designated image. (1) parameter: None

(2) return value

If a function is operated successfully, returns true but if fails, returns false.

bool GetRawImage(int nID, char *buffer)

Returns an image obtained by designated camera to a buffer. The image information is stored as 24bit RGB data.

(1) parameter
[in] nID Camera I.D.
[out] buffer buffer to store image data

(2) return value

If a function is operated successfully, returns true but if fails, returns false.

bool GetConpressedImage(int nID, char *buffer)

Returns an image obtained by designated camera to a buffer. The image information is stored in the type of JPEG.

(1) parameter
[in] nID camera I.D.
[out] buffer buffet to store image data

(2) return value

If a function is operated successfully, returns true but if fails, returns false.

ZOOM_INFO GetCameraZoomInfo(int nID)

Returns information of zoom of designated camera.

(1) parameter
[in] nID camera I.D.

(2) return value: ZOOM_INFO

Information of zoom of a designated camera

int GetCameraZoom(int nID)

Obtains the current zoom factor of designated camera.

(1) parameter
[in] nID designate camera ID

(2) return value

Returns the current zoom factor of a designated camera.

bool ZoomTo(int nID, int nFactor)

Performs operations zooming a designated camera.

(1) parameter
[in] nID designates camera I.D.
[in] nFactor designates a zooming factor value.

(2) return value

If a function is operated successfully, returns true but if fails, returns false.

The robot common interface and the robot common framework defined as above determines if a command implementation is completed by the following method.

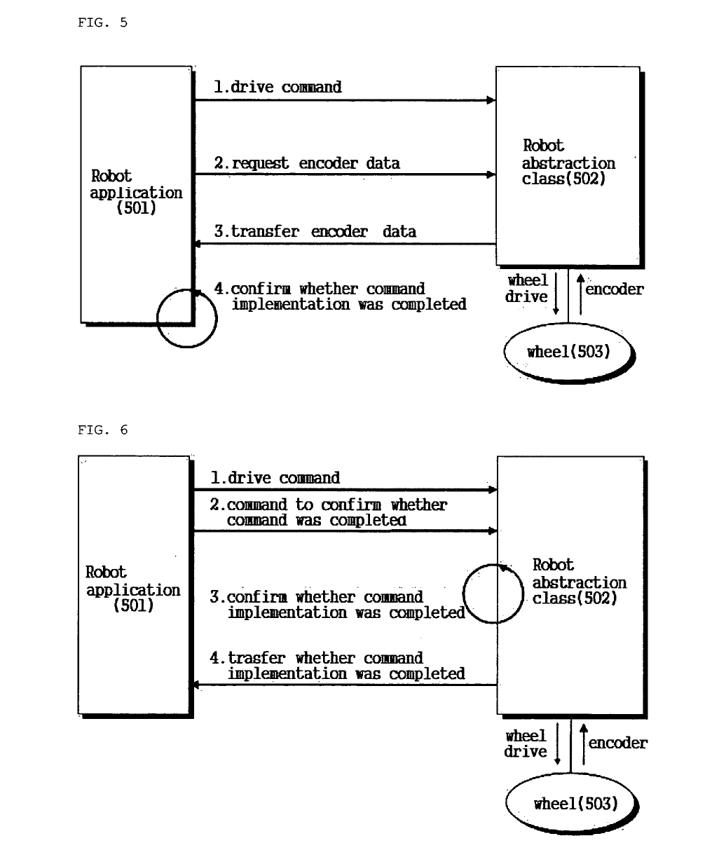

FIG. 5 is a block diagram showing a process for checking if the command implementation is completed.

The robot common framework adapted as a standard of a robot consists of a robot application (501) and a robot abstraction class (502) which transmit and receive information through a robot common interface. The robot application (501) carries out a calculation with a high load and produces and transmits a command performed by the robot abstraction class (502). The robot abstraction class (502) receives an implementation command transmitted by the robot application (501), performs the command and transmits the information of robot status. The commands of such robot application (501) and the information of robot status of the robot abstraction class (502) are transmitted in the standardized type through a robot common interface. At this time, a robot common interface may be carried out by local calls or carried out by remote calls through a network.

Here, the robot application (501) should know if the robot abstraction class (502) completes the commands. Referring to FIG. 5, a method for determining if the robot abstraction class (502) performs commands is to detect if a robot abstraction class completes a command using stats information like a motor encoder data.

In other words, the robot application (501) transmits drive commands at a predetermined portion of a robot to the robot abstraction class (502) (1). The robot abstraction class (502) received the drive commands drive the corresponding devices in accordance with the drive commands. FIG. 5 shows a case that a command to drive wheels (503) of a robot is transmitted. After the robot drives the wheels (503), an encoder data thereof is produced. Then, the robot application (501) requires the robot abstraction class (502) to transmit encoder data (2), and the requested robot abstraction class (502) transmits the encoder data to the robot application (501) (3). The robot application (501) received the encoder data analyzes the encoder data and determines if the command is exactly performed in accordance with a drive command transmitted to the robot. As the above driving method transmits a great amount of data to the robot application, if the communication data or the synchrony of the robot abstraction class (502) and the robot application (501) is abnormal, there is a possibility to generate some problems in the methods to detect if a command is implemented. Accordingly, it is preferable that the following detecting methods be used.

FIG. 6 is a block diagram showing a process to check if a command implementation is completed in accordance with an embodiment of the present invention.

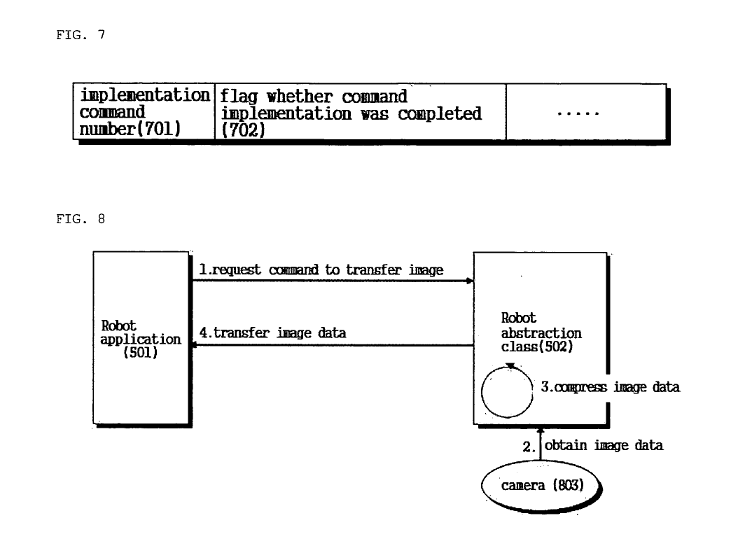

Referring to FIG. 6, the robot application (501) transmits a predetermined drive command to the robot abstraction class (502). It is preferable that the drive command be realized variously in accordance with a desired device for driving but the present invention shows an example to drive robot wheels. The robot application (501) transmitted the drive command transmits a command if a command is completed again (2). The command to confirm if the command is completed is transmitted in the type of a packet in FIG. 7. Referring to FIG. 7, an implementation command number frame (701) is placed at the first terminal and an flag frame if a command implementation is completed (702) is placed at the next terminal. As described above, the robot abstraction class (502) which received a command to drive a wheel and a command to confirm if a command implementation is completed drives the wheels of a robot. The robot driving the wheels obtains an encoder information after the wheel drive is completed and confirms if the command implementation is completed using the information (3). The robot abstraction class (502) which confirmed that the command implementation is completed transmits an information whether the command implementation is completed to the robot application. Then, the robot application received the information whether the command implementation is completed confirms if the drive command sent by itself is exactly performed (4).

A camera control interface proceeds to the following process in order to obtain an image in the corresponding robot.

FIG. 8 is a block diagram schematically showing a process for transmitting and receiving an image in accordance with an embodiment of the present invention.

Referring to FIG. 8, the robot common framework defined in the present invention consists of a robot application (501) and a robot abstraction class (502) which send and receive information through a robot common interface. The robot application (501) carries out image-based various applied calculations and requires the robot abstraction class (502) to transmit an image data (1). The robot abstraction class (502) obtains an image using a camera (503) mounted in a robot (2) and transforms the obtained image into the type defined in a robot common framework (3) and transmits it to the robot application (501) (4). The robot application (501) which received an image transmitted by the robot abstraction class (502) carries out applied calculations such as detecting human beings.

The robot application (501) and the transmitting and receiving image of a robot abstraction class (502) are transmitted in a standardized type through a robot common interface so that the robot application (501) is realized independently on a hardware. At this time, the robot common interface may be carried out by local calls or remote calls through a network.

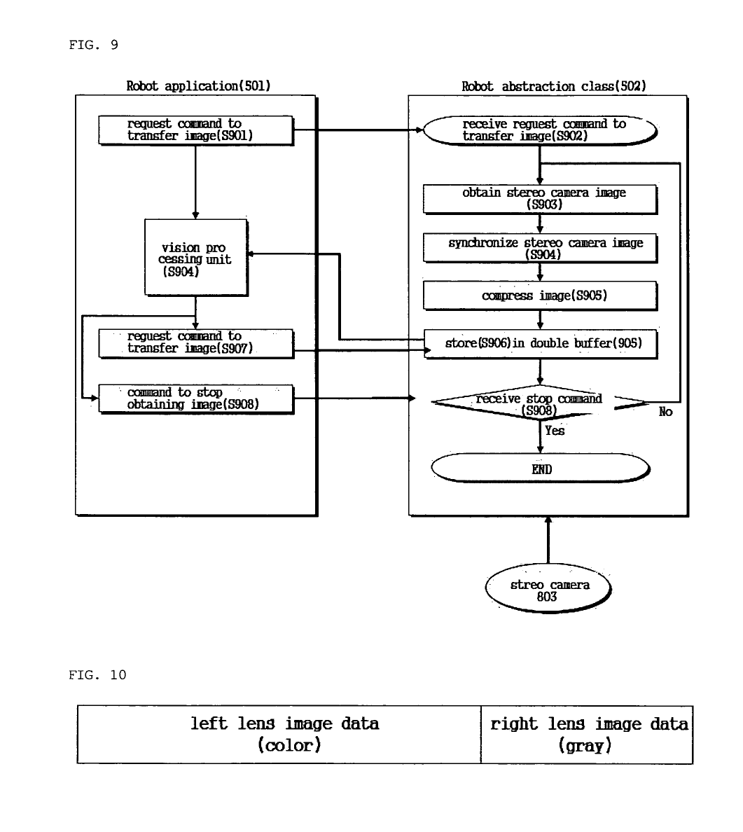

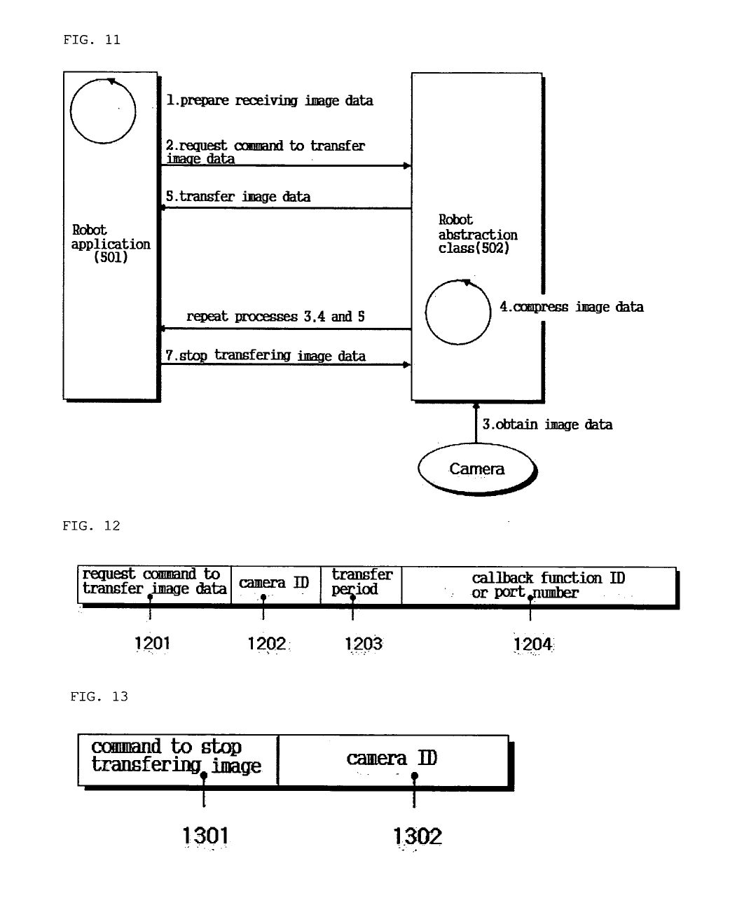

FIG. 9 is a flow chart showing a process for transmitting and receiving image data of a camera in accordance with an embodiment of the present invention.

Referring to FIG. 9, the robot application (501) has a code for requesting the robot abstraction class (502) to obtain an image data and a vision processing unit (904) for receiving and processing the image data transmitted from the robot abstraction class (502). The vision processing unit (904) receives image data from the robot abstraction class (502) and reads in the transmitted image data to perform a vision processing like detecting a face.

In an embodiment of the method for transmitting and receiving a camera image according to the present invention, the robot application (501) transmits a request command to transfer an image to a robot abstraction class (S901). If the robot abstraction class receives a request command to transfer an image (S902), an image is obtained from the stereo camera (803) (S903), the obtained image is synchronized with respect to each lens of a stereo camera (S904) and compressed (S905) and stored in a double buffer (S906).

In case that a request command to transfer an image is transferred from the robot application (501) (S901), the image stored in the double buffer is transferred to the robot application (501).

In case that a command to stop obtaining an image is not transferred from the robot application (501) (S909), the steps from obtaining the image (S903) to storing the image in the double buffer (S906) or occasionally from transferring a request command to transfer an image (S907) to transferring an image are repeatedly performed. In case that a command to stop obtaining an image from the robot application (501) is transferred (S908), the processes after the step for obtaining an image (S903) are no more performed.

One of the major features of the methods for transmitting and receiving the camera image is to obtain an image by the stereo camera (S803). The stereo camera (803) is provided with two lens placed in different positions and obtains at least two images with respect to a subject at the same time. In the above embodiment, a stereo camera capable of obtaining two images by two camera lens arranged in left and right is used.

API commands to start obtaining an image in order to shoot and obtain a stereo image by the stereo camera (503) from the robot abstraction class (502) in the application (501) can be constituted as follows,
bool StartStereoImage(CONTEXT context1, CONTEXT context2)

The parameters of API commands include context 1 indicating a left camera lens and a context 2 indicating a right camera lens, each CONTEXT including the information of a camera ID, the size of an image to be shot and a color level.

A command to start obtaining an image using a stereo camera is transmitted to the robot abstraction class (502) by the API command (S901). At this time, the command to start obtaining an image designates the used camera ID, the size of an image to be shot and a color level.

In the present invention, an image shot by the stereo camera (803) is required to be obtained to equalize the synchrony of an image shot by the left and right lens. In addition, a process of rectification to decrease an effect by lens distortions of a camera must be implemented. In order to make it, an API function can be defined as follows,
bool GetStereoImage(BYTE** plmg1, BYTE** plmg2)

The parameters of the API command, plmg1 represents a pointer of a left image and plmg2 represents a pointer of a right image, respectively.

The image obtained by the stereo camera is synchronized by the API command and an effect due to distortions of a camera is amended (S904).

In the embodiment, the process for obtaining a camera image started by the start command to obtain the image (S901) is performed until the command to stop obtaining an image (S908) is transferred from the robot application (501).

An API function for commands to stop obtaining the image can be defined as follows,
bool EndStereoImage(CONTEXT context1, CONTEXT context2)

The command to stop obtaining the image should stop obtaining an image with respect to both left and right lens of a stereo camera. The parameters of the API function are context1 and context2 representing the information of the left and right camera lens like the API function for the command to start obtaining an image.

In the above embodiment, the obtained image (S903) is synchronized (S904), compressed (S905) and stored in the double buffer (S906) and the image data stored in the double buffer is transmitted to the robot application only if the request command to transfer an image (S907) is transferred from the robot application (501).

The double buffer is provided with at least two buffers to store two data at the same time and the camera images obtained are alternately stored in two buffers in accordance with an acquiring order in the embodiment.

In the above embodiment, in case that a request command (S907) to transfer an image is transferred from the robot application (501), the data stored earlier of two data stored in the double buffer is transferred to the robot application. This is because the step for obtaining a new image using a camera (S903) is performed at the same time or shortly after the step for storing the image acquired earlier in the double buffer (S906).

As the image obtained by the stereo camera is synchronized and compressed and then stored in a buffer and sometimes is transferred to a robot application, it is possible to receive a camera image obtained from the robot abstraction class only if a predetermined time for processing an image is delayed after the robot application orders to start obtaining an image.

In case that a double buffer is used like in the embodiment, one buffer is used to store and the other buffer is used for processing the newly obtained image in order to transfer the obtained image to a robot application. Therefore, the step (S903) for obtaining a new camera image is performed with the step (S906) for storing the earlier acquired image in the double buffer at the same time. In addition, even if the newly obtained image is processed, the earlier stored image may be transferred to a robot application, and thus a problem of delaying time due to the processing of an image is solved more or less.

In the embodiment, the image obtained by the stereo camera (803) is transferred to the robot application (501) from the robot abstraction class (502). In case that the acquired image is a colored image, there is a problem of transferring at a high speed due to a large amount of data.

In a general robot application, the color of an image and the color information can be sufficiently obtained with one camera. In case that a three-dimensional distance should be extracted, it is required to obtain two synchronized images with a stereo camera, etc. In addition, the three-dimensional distance can be sufficiently extracted using a gray image, also.

Accordingly, an image by one of a stereo camera lens should be represented in a colored image but an image by the other lens can be represented in a gray color. In the above embodiment, the left lens of a stereo camera obtains a colored image and the right lens obtains a gray image to transfer the image.

The examples of the types of data of an image obtained by the stereo camera are shown in FIG. 7. The images obtained by the left and the right lens of the stereo camera have the same size of 320*240 number of pixels but the image by the left lens is represented in 24 bits by RGB color information and the image by the right lens is represented in 8bits to show only light and shade information.

Whereas the amount of data to be transferred is 3,686,400 bits if images by two lens of the stereo camera are transferred in color, the amount of data to be transferred is 2,457,600 bits if one image is transferred in color and the other image is transferred in gray, decreasing the amount of data by the level of ⅔. Under a network to transfer one image of 230*240 pixels at the speed of 30 frame/sec, if two color stereo images are transferred, the transfer speed is decreased below 15 frame/sec but if one image is transferred in color and the other one image is transferred in gray, it is possible to transfer data at 22.5 frame/sec in other words, image can be transferred at a high speed.

FIG. 11 is a flow chart showing a method for obtaining an image continuously in a robot in accordance with another embodiment of the present invention.

Referring to FIG. 11, the robot application (501) orders the robot abstraction class (502) to transfer an image data in order to receive an image data (2). The robot abstraction class (502) which received the request command to transfer the image data obtains the current image data from a predetermined camera (503) and compresses it (3, 4). The compressed image data is transferred to the robot application (501) (5). The compressed image data is continuously transferred to the robot application (501) with a regular period. If the robot application (501) no more wants to receive an image data, it orders to stop transferring image data (7). The robot abstraction class (502) which received a command to stop transferring the image data no more transfer an image data.

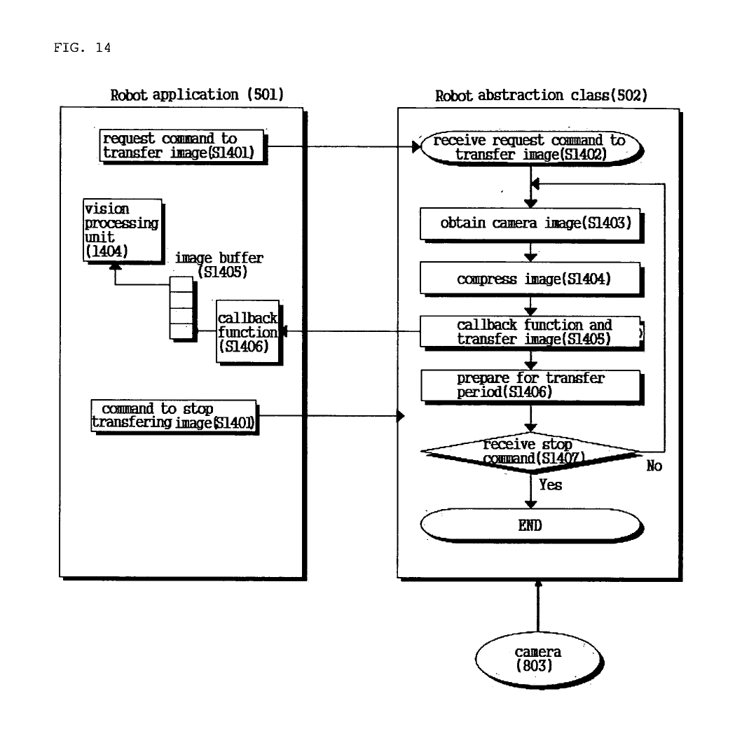

FIGS. 12 and 13 show a data frame to a request command to transfer an image and a command to stop transferring an image in accordance with an embodiment of the present invention.

Referring to FIG. 12, the request command to transfer an image includes an information of a request command to transfer an image (1201), a camera ID information (1202), a transfer period (1203) and a callback function ID or a port number information (1204). It is preferable that the length of a frame for including each information be at least 4bytes. It is preferable that the length of a frame representing an information of a request command to transfer the image be changeable. The information of a request command to transfer an image (1201) shows that the current command is an information of a request command to transfer an image. The camera ID (1202) determines which camera receives an image data out of at least one camera provided in the corresponding robot and the transfer period (1203) determines a time interval at which the image data obtained from the outside is transferred to the robot application. In case that the request command to transfer the image is transferred to a robot application, an ID of a callback function is included in order to continuously perform commands before the commands are transferred, and the port number includes an information to determine the address of a network in case that the corresponding robot is controlled through a network.

FIG. 13 shows the structure of a data of a command to stop transferring an image in accordance with an embodiment of the present invention. Referring to FIG. 13, the command to stop transferring the image includes a frame (1301) representing a command to stop transferring the image, and a frame (1302) representing a camera ID. The camera ID (1302) includes an ID information of a camera to stop transferring an image.

FIG. 14 is a flow chart showing a process for transmitting and receiving a continuous image data in accordance with an embodiment of the present invention.

Referring to FIG. 14, the robot application (501) has a vision processing unit (1404), am image buffer (1405) and a callback function (1405) in order to obtain an image data continuously. If an image data is in the image buffer (1405), the vision processing unit (1404) reads in an image data, performs a vision processing like detecting a face and deletes the image data. The image buffer (1405) plays a role in storing an image data transferred by the robot abstraction class (502) using a callback function (1406) and temporarily processing the image so that the vision processing unit (1404) processes an image. The callback function (1406) exists in the robot application but is performed by the robot application (502). The callback function (1406) is used to transfer the image to the image buffer (1405).

First, the robot application (501) transfers a request command to transfer an image to the robot abstraction class (S1401). The request command to transfer an image includes a camera ID, a transfer period and a pointer of a callback function. The camera ID refers to the number of a camera to be acquired. The transfer period refers to the number of transfer frames per second and make the request command to transfer an image prepare how many frames of images will be transferred to the robot application (501) per second. The pointer of a callback function is a pointer used to call a callback function of a robot application by the robot abstraction class.

If the robot abstraction class receives a request command to transfer an image (S1402), an image is obtained from the camera (803) (S1403) and compressed (S1404) and transferred to robot application (501) (S1405) by calling a callback function. And then a waiting operation is performed for a regular time in order to comply with an image transfer period (S1406). At this time, the robot abstraction class (502) repeats the process for obtaining, compressing and transferring the image until a command to stop transferring an image is received so that the robot application continuously receives an image.

In case that the robot application (501) is to finish a vision processing for some reasons, a command to stop transferring an image is transferred to the robot abstraction class (502) (S1407). If the robot abstraction class (502) receives a command to stop transferring image (S1407), the process for obtaining, compressing and transferring the image is stopped to finish the image transfer process.

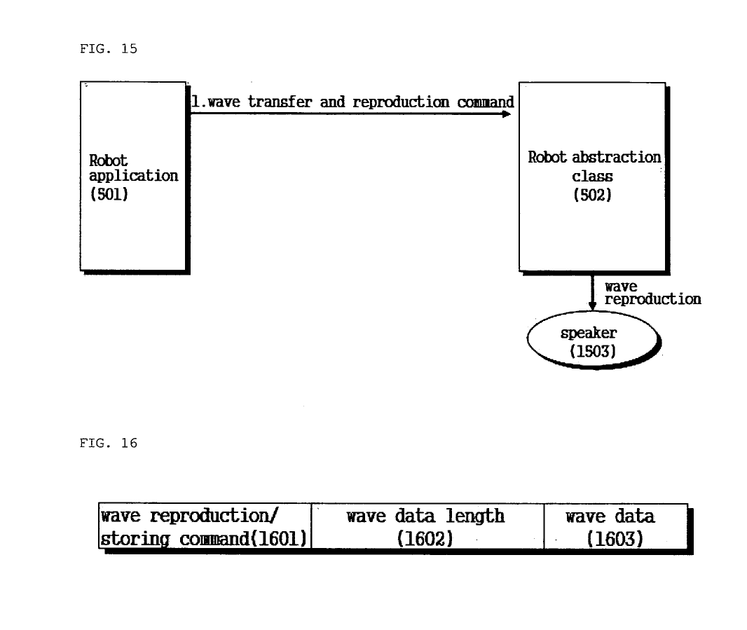

FIG. 15 is a block diagram showing a transfer of waves and a process to transfer reproduction commands in accordance with an embodiment of the present invention.

Referring to FIG. 15, the robot application (501) transfers a sound data to be reproduced by the robot abstraction class (502) mounted in a robot. The robot abstraction class (502) receives a sound data transferred by the robot application (501) and outputs a sound using the speaker (1503). The sound transfer/reproduction command of the robot application (501) and the robot abstraction class (502) is transferred in the standardized type through a robot common interface. At this time, the robot common interface may be performed by local calls or by remote calls through a network.

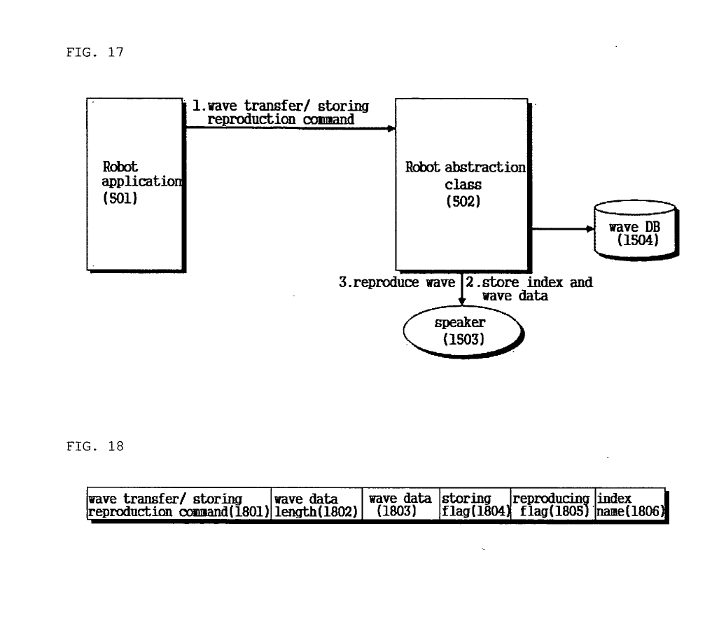

FIG. 16 is a structural view showing a transfer of waves and a reproduction command packet.

Referring to FIG. 16, the wave transfer and reproduction command packet includes a command header (1601), a wave data length (1602) and wave data information (1603). The robot abstraction class (502) which received the wave transfer and reproduction command packet reproduces the corresponding waver data (1603).

FIG. 17 is a block diagram showing the storing waves and a flow of reproduction commands in accordance with an embodiment of the present invention.

Referring to FIG. 17, the robot application (501) stores wave data to be reproduced and a transfer command in the robot abstraction class (502). At this time, in the case that the wave data is a frequently used data, a storing command is simultaneously transferred. The robot abstraction class (502) which received the wave storing and reproduction command (1) stores the wave data included in the command in the database (1504) and arranges it under an index and then reproduces the stored wave data via the speaker (1503). The above process now will be described in view of a command packet, again.

FIG. 18 shows the structure of a data included in the wave storing and reproduction command packet in accordance with an embodiment of the present invention.

Referring to FIG. 18, the wave storing/reproduction command includes a command header (1801), a wave data length (1802), a wave data (1803), a storing flag (1804), a reproduction flag (1805) and an index name (1806). The command header (1801) shows that the currently transferred command is a field to represent a wave storing/reproduction command and the wave length (1802) represents the wave data length included in the current wave storing/reproduction command. The wave data (1803) includes a sound data to be really reproduced and stored. The storing flag (1804) shows that the current wave storing/reproduction command is used for storing a wave data and the reproduction flag (1805) shows that the current wave storing/reproduction command is used for reproducing a wave data. The index name (1806) refers to the name including the corresponding wave data.

FIG. 19 is a block diagram showing a wave reproduction command in accordance with an embodiment of the present invention.

Referring to FIG. 19, the robot application (501) transfers a wave reproduction command to the robot abstraction class (502). In this case, the transfer command does not include a wave data desired to be reproduced because the wave data desired to be reproduced is not stored in the wave database (1504) of the robot abstraction class (502). The robot abstraction class (502) which received the wave reproduction commands extracts the corresponding wave data in comparison with index names (2) and reproduces it via the speaker (1503) (3).

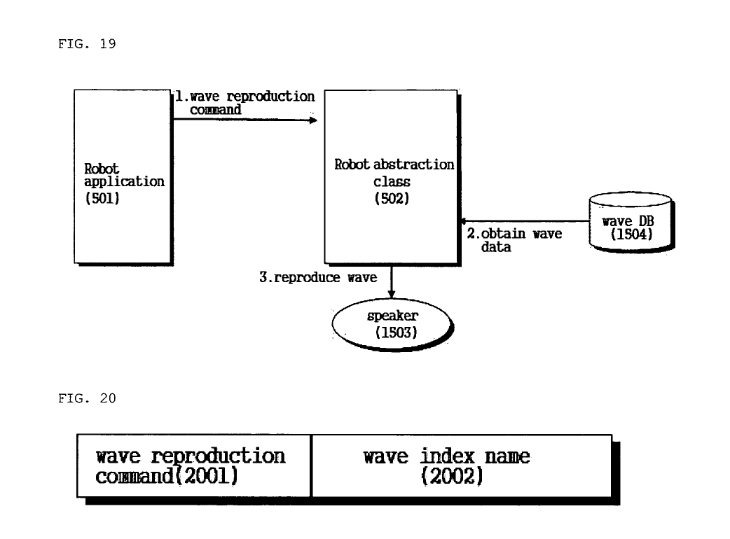

FIG. 20 is a structural view showing a wave reproduction command packet.

In the embodiment, the wave reproduction command includes a command header (2001) and a wave index name (2002). The command header (2001) is a field to show that the corresponding command is a wave reproduction command and the index name (2002) is a name having the wave data desired to be reproduced out of the wave data stored in the wave database.

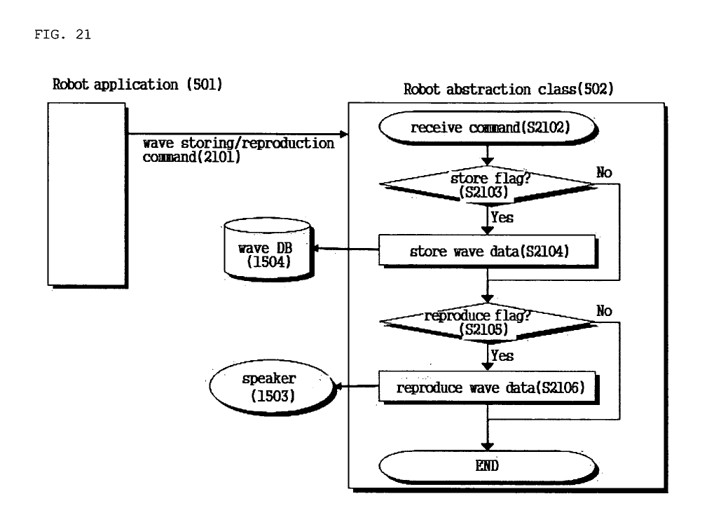

FIG. 21 is a flow chart showing a process for transferring wave reproduction/storing commands in accordance with another embodiment of the present invention.

If a robot application (501) transfers a wave data to the robot abstraction class (502), the robot abstraction class (502) reproduces the wave data to the speaker (1503) therefore it provides human beings with profitable services. In case of a frequently reproduced wave data, a robot abstraction class is made to store the wave data.

The robot application (501) transmits a wavedata reproduction/storing command to the robot abstraction class (502) (S2101). As shown in FIG. 8, the wavedata reproduction/storing command consists of a command header, the wavedata length, a wavedata, a reproduction flag, a storing flag and wave index names. The wavedata length and the wavedata refer to a wavedata to be reproduced by the robot abstraction class (502) or a file. The reproduction flag indicates if a wavedata which received a robot abstraction class is output to a speaker. The storing flag indicates if the robot abstraction class stores a wave data to a wave DB. The wave index names are used to store a wavedata.

The robot abstraction class (502) includes the speaker (1503) and the wave database (1504). The speaker (1503) is a device for transforming the wavedata into a sound signal and the wave database (1504) is a space for storing the wave data.

If the robot application (501) transmits a wavedata reproduction/storing command to a robot abstraction class (s2101), the robot abstraction class processes this command (s2102). First, if the storing flag is “Yes” (S2103), the wavedata is stored in the wave DB (1504) in the robot abstraction class (S2104), using the wave index name as an index. If the storing flag is “No” (S1105), a storing routine is not performed. In addition, if the reproduction flag is “Yes” (S1105), the robot abstraction class (502) reproduces a wavedata through the speaker (1503). If the reproduction flag is “No”, the robot abstraction class does not reproduce a wavedata.

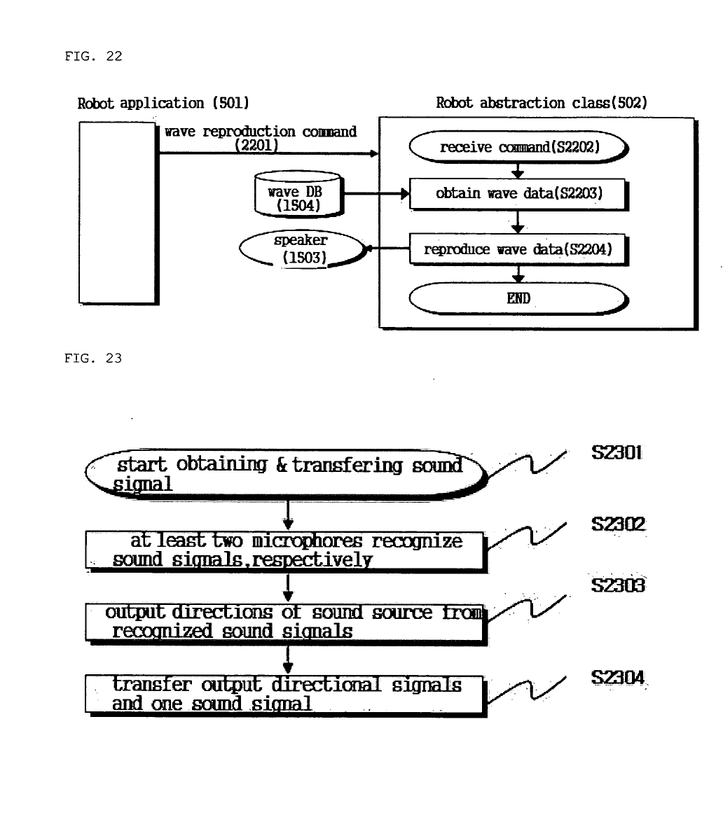

FIG. 22 is a flow chart showing a wave reproduction command in accordance with an embodiment of the present invention.

In case that the robot application (501) reproduces a wavedata stored in a wave database of the robot abstraction class (502), the robot application (501) transmits the wavedata reproduction command to the robot abstraction class (502) (S2201). As the wavedata reproduction command includes a wave data index, it refers to a wave data distance to be reproduced.

The robot abstraction class (502) which received the wavedata reproduction command acquires the wavedata stored in a wave DB using an index (S2202, S2203) and outputs the wavedata to the speaker (1503) (S2204).

FIG. 23 is a flow chart showing a process for performing an embodiment of a method for transferring a sound data of an intelligence service robot in accordance with the present invention.

In FIG. 23, a method for collecting and transmitting a sound data from an intelligence service robot to a server includes: recognizing sound signals in at least two sound recognition mike (S2302), respectively; extracting a directional information of a sound source of a sound signal of the recognized at least two sound signals and producing a directional signal (S2303); and collecting one of the directional signal and the sound signals recognized in the sound recognizing mike and transferring it to a server as a sound signal (S2304).

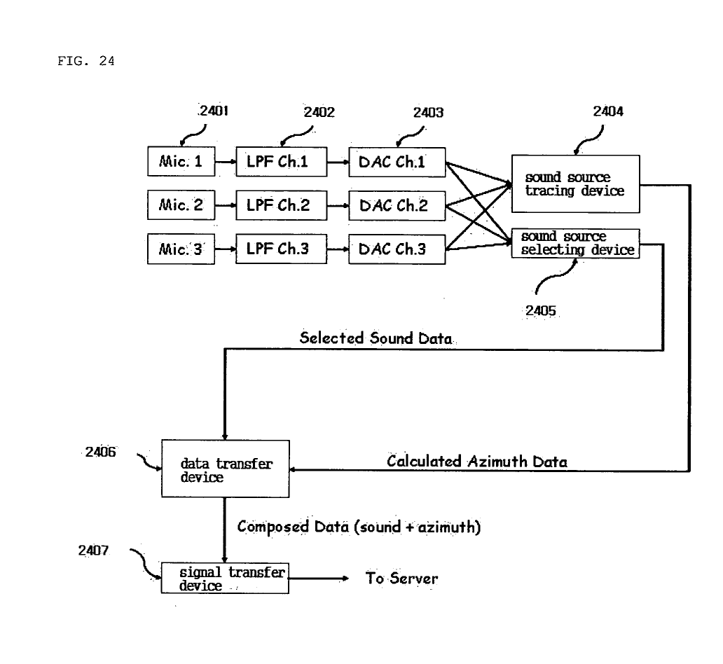

FIG. 24 shows a part of an embodiment of an intelligence service robot in accordance with the present invention, more specifically a part related to transferring a sound data. The embodiment of the method for transferring a sound data shown in the embodiment of FIG. 23 is performed by the embodiment of FIG. 24.

In FIG. 24, referring to transferring a sound data, the intelligence service robot includes: at least two sound recognition mike receiving sound signals (2401), a filter for filtering the signals input to the mike (2402), an A/D transformer performing an analog-digital transformation with respect to the filtered sound signal (2403), a sound source direction tracing unit (2404) for tracing directions of a sound source from the sound signals transformed in the A/D transformer (2403), a sound source selector (2405) for selecting one of sound signals transformed in the A/D transformer (2403), a data transformation device (2406) for transforming the directional signals output from the sound source direction tracing unit (2404) and the sound signals selected from the sound source selector (2405) to a type appropriate for a transfer and a signal transferring device (2407) for transferring data output from the data transformation device (2406) to a server.

The at least two sound recognizing mikes (2401) are an mike array consisting of a plurality of microphones and the same sound generated from one sound source has different values of a recognized sound signal depending on the difference of relative positions with respect to a sound source of a mike.

The sound source direction tracing unit (2404) receives and analyzes a sound signal digitalized by the A/D transformer (2403) to output a direction signal including information of a direction of a sound source.

It is preferable that the sound source direction tracing unit (2404) obtain directional information of a sound source by the method for tracing directions of a sound source using concepts of interaural intensity/level difference (IID/ILD) or interaural time difference (ITD) in accordance with positions recognizing a sound.

It is preferable that the direction signal be output in the type of an azimuth in a binary number with respect to central points of positions of mikes in an intelligence service robot or a predetermined point like a position of a driving means generating a rotational movement or a mobility movement and can be represented below the size less than 2 bytes.

The sound source selector (2405) selects one of sound signals which recognized in at least two mikes (2401) and digitalized by the A/D transformer (2403).

One of the sound signals is selected by the sound source selector (2405) so that the selected sound signal is transferred to a server and the contents of the sound signal is understood in the server.

It is preferable that the sound source selector (2405) select the signal which shows the contents of a sound most clearly out of the sound signals recognized and digitalized by at least two mikes. Especially, it is preferable that a sound signal with the largest size or the sound signal with the largest signal to noise ratio be selected.

The direction signals output from the sound source direction tracing unit (2404) and the sound signal selected in the sound source selector (2405) are transformed in the data transformation device (2406). The data transformation device (2406) collects the direction signal and the selected sound signal to configure a data in a type suitable to be transferred to a server. The data of the configured result can be any structure. For example, the data can be transformed into a type which adds a direction signal data to a bit stream of the selected sound signal.

The data transformed by the data transformation device (2406) is transferred to a server from the signal transfer device (2407), and thus a transfer of a sound data to an intelligence service robot is completed.

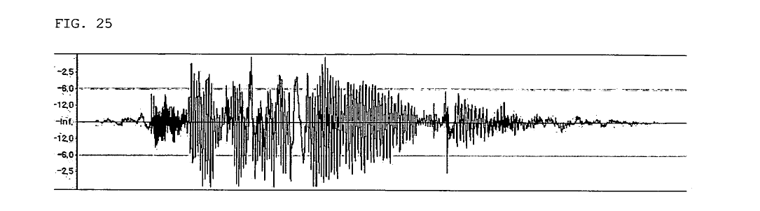

FIG. 25 shows an example of a sound signal recognized by one sound recognizing mike in an intelligence service robot in accordance with the present invention. In case that the above sound signal is digitalized, it is represented in the minimum tens of bytes in accordance with conditions of analog-digital transformation like a sampling rate.

In case that a sound signal is transferred to a server in a conventional intelligence service robot, all sound signals recognized by a plurality of mikes should be transferred, therefore the amount of data to be transferred is very large.

According to the intelligence service robot and the method for transferring a sound data in accordance with the present invention, only the data with respect to one sound signal and data of directional signals with the size less than several bytes are transferred, therefore the amount of data to be transferred increases a lot.

The intelligence service robot diversified some functions like a control function or a calculation function to a server and is controlled by the controls of the server. In other words, the robot and the server have the same structure as the client and server. In this case, the application provided in the server decreases the dependence on a robot device being a client and improves the portability between robot platforms of each client of the application. Thus, it is beneficial in efficiently developing and improving the application driving the robot and the intelligence service robot.

Accordingly, the robot of the client is required to be defined as a robot having a common interface, and therefore there is an attempt to set up a kind of imaginary robot model and define a common interface based on the model in order to deduce a common interface with respect to intelligence service models with various characteristics and kinds in accordance with components and hardwares.

In an instance, according to the common robot interface standard for abstracting a URC device of the Korea Information Communication Technology Association, a robot interface is provided with a differential type wheel driving device, a pan-tilt head with a camera, a distance sensing device capable of measuring the distance from the object outside the robot, a collision prevention bumper sensor, sound receiving mikes, sound outputting speaker device, an image device for obtaining an image outside the robot and a battery voltage detecting device.

According to the standard, the robot of the above interface becomes a client and the server is mounted with an application for driving and controlling the robot. At this time, the robot according to the standard includes a common interface and can be driven by an application provided with respect to the interface.

Accordingly, one application can drive a plurality of robots with an interface whose platforms are different from each other but complies with the standard and a plurality of programs whose contents are different from each other but formed in consideration of the standard interface can be adjusted with respect to one robot. Thereby, an independence, a flexibility and a transplantation in developing applications and robots are improved to promote the development and the improvement of an application and a robot.

According to the above standard, in case that the intelligence service robot being a client receives a sound signal, the intelligence service robot receives the sound signal from the mikes. At least two mikes are provided in the client.

In case that a sound data is transferred from a client to a server between a server and a client in accordance with the standard, it is beneficial to decrease the amount of data to be transferred in the communication network between a server and a client according to a method for transferring a sound data of an intelligence service robot of the present invention. Therefore, it is preferable that the transfer of a sound data under the above standard be carried out by a method for transferring a sound data of the present invention.

What is claimed is:

1. A method for detecting if a command is performed on a robot common framework, comprising:
transferring a command to drive a robot to a robot abstraction class by a robot application;
transferring a command to confirm if a command is completed to the robot abstraction class by the robot application;
confirming if the robot abstraction class completes the command; and
transferring if a command is completed to the robot application by the robot abstraction class.

2. The method of claim 1, wherein the data having the robot abstraction class showing if a command is completed with the robot application includes a command implementation number and a flag data if a command is completed.

3. The method of claim 1, wherein a method for confirming if the robot abstraction class performs a command implementation is determined by analyzing an encoder by the robot abstraction class after the corresponding command is performed.

4. A method for transmitting and receiving a camera image signal on a robot common framework, comprising:
requesting a robot application to transfer an image data to a robot abstraction class;
obtaining an external image data by a robot abstraction class required to transfer the image data; and
transferring the image data obtained by the robot abstraction class from the outside to the robot application; and
wherein the step for obtaining an external image data by the robot abstraction class has two lens with different positions and obtains an image using a stereo camera capable of obtaining at least two images simultaneously with respect to one subject.

5. The method of claim 4, further comprising: a step of compressing an image data obtained from the outside into a compressed data type before the image data obtained by the robot abstraction class from the outside is transferred to the robot application.

6. The method of claim 4, further comprising: a step for adjusting a synchrony of an image obtained by at least two lens provided in the stereo camera after the step for obtaining an external image data by a robot abstraction class required to transfer the image data.

7. The method of claim 4, wherein the step of obtaining an external image data by the robot abstraction class and the step of transferring the external image data obtained by the robot abstraction class to the robot application are repeatedly carried out until the robot application requests to stop transferring the external image data.

8. The method of claim 4, wherein the step of transferring the image data obtained by the robot abstraction class from the outside to the robot application stores the image data obtained from the outside in a double buffer provided with two buffers and transfers the same.

9. The method of claim 4, wherein the step for transferring the image data obtained by the robot abstraction class from the outside to the robot application stores the image data obtained from the outside in two buffers provided in the double buffer alternately in accordance with the order of obtaining the external image data when storing in a double buffer.

10. The method of claim 4, wherein the step for transferring an image data obtained by the robot abstraction class from the outside to the robot application includes a step for transferring the first stored image data of the image data stored in two buffers provided in the double buffer to the robot application.

11. The method of claim 4, wherein the step for obtaining an external image data by the robot abstraction class is performed at the same time when data is stored in a double buffer in the step for transferring the image data obtained by the robot abstraction class to the robot application.

12. The method of claim 4, wherein the step for transferring an image data obtained by the robot abstraction class from the outside to the robot application includes a step for transferring the obtained image data to the robot application in case that a request command to transfer an image is delivered from the robot application.

13. The method of claim 4, wherein an image shot by one lens of the stereo camera is represented as a colored image and an image shot by the other lens of the stereo camera is represented as a black and white image.

14. A method for transmitting and receiving a camera image signal on a robot common framework, comprising:
requesting a robot application to transfer an image data to a robot abstraction class;
obtaining an external image data by a robot abstraction class required to transfer the image data; and
transferring the image data obtained from the outside to the robot application before the robot application requests to stop transferring the external image data.

15. The method of claim 14, wherein the robot abstraction class obtains an image data using at least one camera.

16. The method of claim 14, wherein the image data obtained from the outside is transferred to the robot application by the robot abstraction class in a type of compressed data.

17. The method of claim 14, wherein a command to be transferred so that the robot application requires the robot abstraction class to transfer an image data includes a command frame for requesting an image transfer, a camera ID frame, a transfer period frame and a callback function ID or a port number frame.

18. The method of claim 14, wherein a command data to be transferred so that the robot application requires the robot abstraction class to stop transferring an image data includes a command frame for stopping an image transfer and a camera ID frame.

19. The method of claim 14, wherein the processes that the robot abstraction class required to transfer the image data obtains the external image data and transfer the same to the robot application are repeated until the robot application requires the robot application to stop transferring the external image data.

20. The method of claim 19, wherein the image data obtained from the outside is transferred to the robot application with a regular period.

21. The method of claim 14, wherein the image data obtained from the outside by the robot abstraction class is temporarily stored in an image buffer.

22. A method for managing a sound signal on a robot common framework in the method for transmitting and receiving a camera image signal on a robot common framework, comprising:
transferring a wave storing/reproduction command including sound data in a robot application to a robot abstraction class; and
managing the sound data included in the wave storing command in a database.

23. The method of claim 19, further comprising: reproducing the sound data included in the wave storing command.

24. A method for managing a sound signal on a robot common framework in the method for transmitting and receiving a camera image signal on a robot common framework, comprising:
transferring a wave reproduction command in the robot application to a robot abstraction class; and
extracting and reproducing data from the database by the robot abstraction class which received the wave reproduction command.

25. A method for managing a sound signal on a robot common framework in the method for transmitting and receiving a camera image signal on a robot common framework, comprising:
transferring a wave reproduction/storing command including sound data in a robot application to a robot abstraction class;
managing the sound data included in the wave storing command in a database;
transferring a wave reproduction command in the robot application to a robot abstraction class; and
extracting and reproducing data from the database by the robot abstraction class which received the wave reproduction command.

26. The method of claim 22, wherein the wave storing/reproduction command includes a command header, a wave data length, a wave data, a storing flag, a reproduction flag and an index name.

27. The method of claim 25, wherein the wave reproduction command includes a command header and a wave index name.

28. The method of claim 24, wherein the wave file is reproduced by a speaker.

29. An intelligence service robot connected to a server by a network, transferring signals collected in the sensor to the server and driven by a control of the server, the robot comprising:
at least two sound recognizable mikes receiving an external sound signal and transforming it into electric signals;
an A/D transformer performing an analog-digital transformation with respect to sound signals transformed into electric signals, respectively;
a sound source direction tracing unit analyzing at least two analog-digital transformed sound signals in the A/D transformer and outputting a directional signal being an information of directions of sound sources producing the sound signal;
a sound source selector selecting one of at least two sound signals transformed in the A/D transformer; and
a signal transferring unit transferring a directional signal output from the sound source direction tracing unit and the sound signal selected in the sound source selector to the server.

30. The intelligence service robot of claim 29, wherein the sound source selector selects one largest sound signal of at least two sound signals transformed in the A/D transformer.

31. The intelligence service robot of claim 29, wherein the sound source selector selects one sound signal with the largest sound to noise ratio of at least two sound signals transformed in the A/D transformer.

32. The intelligence service robot of claim 29, wherein the sound source direction tracing unit outputs the directional signals using an azimuth indicating the positions of a sound source.

33. The intelligence service robot of claim 29, wherein the sound source direction tracing unit outputs the directional signal with the size of below 2 bytes.

34. A method for transferring sound signal data of an intelligence service robot, the method comprising:
recognizing a sound signal in at least two sound recognizable mikes provided in the intelligence service robot;
outputting a directional information of sound source from the sound recognized in at least two sound recognizable mikes; and
transferring one of directional information of the output sound source and the sound signals recognized in at least two sound recognizable mikes to a server controlling the intelligence service robot.

35. The method of claim 23, wherein the wave storing/reproduction command includes a command header, a wave data length, a wave data, a storing flag, a reproduction flag and an index name.

36. The method of claim 24, wherein the wave storing/reproduction command includes a command header, a wave data length, a wave data, a storing flag, a reproduction flag and an index name.

37. The method of claim 25, wherein the wave storing/reproduction command includes a command header, a wave data length, a wave data, a storing flag, a reproduction flag and an index name.

38. The method of claim 25, wherein the wave file is reproduced by a speaker.
